(19) United States
(12) Patent Application Publication
(10) Pub. No.: US 2013/0110796 A1
(43) Pub. Date: May 2, 2013

(54) RECEIVING A DOCUMENT UPDATE TO TRANSMIT A CHANGE

(71) Applicants: David G. Butler, Eagle, ID (US); Andrew Alegria, Meridian, ID (US); Kenneth K. Smith, Boise, ID (US)

(72) Inventors: David G. Butler, Eagle, ID (US); Andrew Alegria, Meridian, ID (US); Kenneth K. Smith, Boise, ID (US)

(21) Appl. No.: 13/281,487

(22) Filed: Oct. 26, 2011

(51) Int. Cl. G06F 17/30

(52) U.S. Cl. 707/695; 707/E17.009

(57) ABSTRACT

Examples disclose herein include receiving a master document and a first document update associated with a first time stamp from a first computing device. The first document update includes a first change to the master document. This example also compares the first document update to the master document to identify the first change. Additionally, the example provides transmitting the first change to a second computing device.

### BACKGROUND

Concurrency issues may arise where a single resource is accessed by a plurality of devices. Concurrent use of shared resources can be a source of indeterminacy leading to issues such as inconsistencies. For example, a concurrency issue may arise among a plurality of devices sharing and accessing a document.

### BRIEF DESCRIPTION OF THE DRAWINGS

In the accompanying drawings, like numerals refer to like components or blocks. The following detailed description references the drawings, wherein:

FIG. 1 is a block diagram of an example server computing device for receiving a document update associated with a first time stamp and sending a first change to a computing device.

FIG. 2 is a block diagram of an example server computing device in communication with a first computing device, a second computing device, and a third computing device.

FIG. 3 is a communication diagram of an example communication between a first computing device, a server computing device, and a second computing device.

FIG. 4 is a flowchart of an example method for receiving a first document update to transmit a first change.

FIG. 5 is a flowchart of an example method for receiving a first and a second document update and adjusting a first and a second time stamp.

FIG. 6 is a block diagram of an example server computing device for receiving a first and a second document update.

### DETAILED DESCRIPTION

Multiple versions of an outdated document may exist on a computing devices. This is also further problematic if there are several users of computing devices making edits to the document as there will be multiple outdated versions of the document.

To address these issues, various examples disclosed herein provide for updates to a document on a computing device. In one example embodiment, a server computing device receives a first document update associated with a first time stamp. The server computing device assigns a version to the first document update based on the time stamp. Additionally, the first document update is compared to a master document to determine a first change to transmit to a computing device. In another example embodiment, the server computing device also receives a second document associated with a second time stamp and calculates a first and a second time difference to adjust the first time stamp and the second time stamp.

In applying the example system and method illustrated herein, a document may be edited off-line as a server computing device receives a document update when a first computing device, such as a laptop, connects to a network. Additionally, the server computing device may track a version of each document update by assigning a version based on the time stamp. This allows the server computing device to determine the more recent document update and to transmit the corresponding changes. Further, the server computing device transmits a change to synchronize a document update among several devices. Further still, the server computing device may calculate a time difference to adjust the first and second time stamp, in the situation that a first and a second document update are received simultaneously or in succession prior to a change being transmitted. Using the adjusted time stamps to assign versions to the document updates reflect utilizing accurate time stamps.

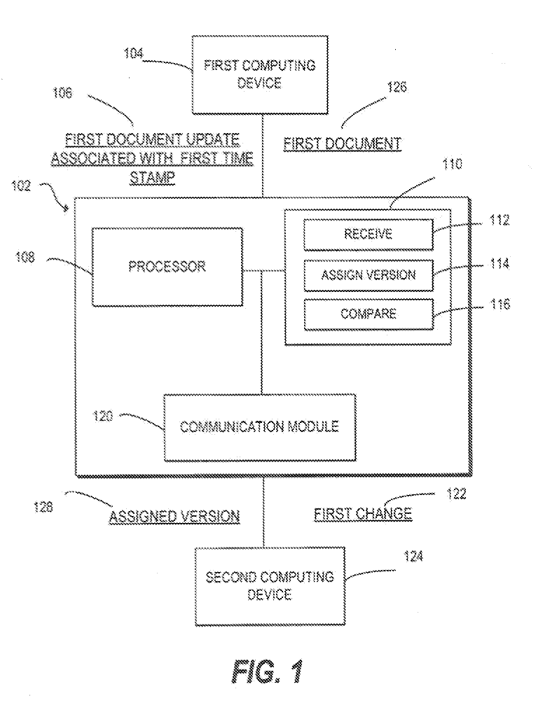

Referring now to the drawings, FIG. 1 is a block diagram of an example server computing device 102 for receiving a first document update associated with a first time stamp 106 from a first computing device 104. Server computing device 102 provide services across a network and may include, for example, a web server, network server, a Local Area Network (LAN) server, a file server, or any other computing device suitable for receiving document updates and time stamps to transmit changes. Hence, the term server computing device 102 may be used interchangeably with server throughout this document. For clarification purposes, the server computing device 102 will be referred to as a server hereinafter. In one example embodiment, server 102 includes processor 108, machine-readable storage medium 110, and communication module 120. Further, it is to be understood although the server 102 includes the depicted components, it should not be limited to containing the components in FIG. 1. For example, the server 102 may include an additional processor and/or communication module, etc.

The first document 126 is received at the server 102 prior to receiving the first document update 106. For example, the first computing device 104 transmits the first document 126 prior to sending the first document update associated with the first time stamp 106. The first document 126 includes a document which is at least one of a word processing file document, a spreadsheet file document, a media file document, Portable Document Format (PDF) file document, or a text file document. The first document 126, also referred to as a master document as seen in later figures and may be used interchangeably throughout. For illustrative purposes herein, the first document 126 will be referenced as a word processing file document.

In one example embodiment, the first document 126 is received at the server 102 from the first computing device 104, in another example embodiment, the first document 126 is received by the server 102 from the second computing device 124, or other computing device. In a further example embodiment, the first document 126 is retrieved from a storage location by the server 102.

First computing device 104 provides the first document update associated with the first time stamp 106. The first computing device 104 may include a client device, personal computer, desktop computer, laptop, mobile device, portable device, or other computing device suitable to provide a document update and a time stamp. The first computing device 104 includes the first document 126 and a first document update associated with the first time stamp 106. The first document update includes at least a change to the first document 126. For example, the first computing device 104 may be a personal computer with a word processing file document that includes a list of names, so a user may edit, change, or update a name in the word processing file, document. The word processing file document with the change comprises the first document update. In some example embodiments, the first computing device 104 places the first document update associated with the first time stamp 106 in a memory, such as a memory cache. When the first computing device 104 connects to a network, the first document update associated with the first time stamp is transmitted from the memory cache to the server 102. Placing the first document update associated with the first time stamp in the memory cache enables the first document update to be created off-line.

The first computing device 104 may also associate the first time stamp with the first document update 106. The time stamp may include a data value representing the time and/or date of an addition, deletion, change, or update of the document. For example, assume there is a word processing file document with a list of names. When a name is changed in this word processing file document, there is a time stamp, such as “18:45” that represents the time of the change. In this respect, the first time stamp is considered associated with the first document update. One example embodiment of the time stamp includes a time and/or date of when the document update is created, updated, and/or stored on the memory of the first computing device 104. A further example embodiment of the time stamp includes a sequence of characters representing the time of the addition, deletion, change, or update. Further, the time stamp may include a may include a time being generated based upon a time function, such as a clock that may include the time on the first computing device 104. Example embodiments of the time function include world time, International Atomic Time (TAI), Terrestrial Time, Coordinated Universal Time (UTC), Global Positioning (GPS) time, or other sort of time generating function.

In a further example embodiment, the first computing device 104 and/or the second computing device 124 may provide additional document updates and changes. For example, the server 102 may receive a second document update from the second computing device 124, and thus the changes corresponding to the second document update may be transmitted to the first computing device 104 to incorporate.

The first document update associated with the first time stamp 106 is received by server 102. In one example embodiment, the first document update associated with the first time stamp 106 may be sent to the processor 108, while in another example embodiment it may be sent to the machine-readable storage medium 110, while in a further example embodiment, it may be sent to the communication module 120. In yet a further example embodiment, the processor may retrieve the first document update associated with the first time stamp from the first computing device 104.

Processor 108 may be a central processing unit (CPU), microprocessor, or other programmable device suitable for instructions on a machine-readable storage medium 110. In particular, processor 108 may fetch, decode and execute modules 112, 114, and 116 from the machine-readable storage medium 110. Modules 112, 114, and 116 may include a single instruction or a set of instructions. In one example embodiment, the processor 108 performs: module 112 to receive the first document update associated with the first time stamp 112, module 114 to assign a version to the first document update, and module 116 to compare the first document update 106 to the first document 126 to identify a first change 122.

Machine-readable storage medium 110 includes executable instructions, firmware, and/or software modules which can be executed by the processor to perform: module 112 to receive the first document update associated with the first time stamp 106, module 114 to assign a version to the first document update based on the first time stamp, and module 116 to compare the first document update 106 and the first document 126 to identify the first change 122. The machine-readable storage medium 110 may be an electronic, magnetic, optical, flash-drive, or other physical device that contains or stores executable instructions. Thus, machine-readable storage medium 110 may be, for example, Random Access Memory (RAM), an Electrically Erasable Programmable Read-Only Memory (EEPROM), a storage drive, a Compact Disc Read-Only Memory (CDROM), and the like. As such, the machine-readable storage medium 110 may be non-transitory. In other example embodiments, the server 102 can include an application and/or firmware which may be utilized independently and/or in conjunction with the processor 108 to fetch, decode, and/or execute the modules 112, 114, and 116 on the machine-readable storage medium 110 and/or stored on another location of the server 102. Although machine-readable storage medium 110 includes modules 112, 114, and 116, it may further include additional instructions as seen in later figures.

Module 112, receives the first document 126 and the first document update associated with the first time stamp 106 on the server 102. As discussed earlier, the processor 108, the machine-readable storage medium 110, or the communication module 120 may receive the first document 126 and the first document update associated with the first time stamp 106.

Module 114 assigns a version to the first document update based on the first time stamp. Embodiments of module 114 include incrementing a count, increasing or decreasing a value, assigning a symbol to track a version of the first document 126. For example, a count may be “010”, thus the count may be incremented to “011” to assign to the first document update. In this example, “011” is considered a more recent version than “010” since “011” is after “010”. Additionally, if more than one document update is received by the server 102, the server determines the more recent document update based on each time stamp. For example, a second time stamp, such as “19:00” is considered a more recent document update than a first time stamp “18:00” since it is later in time. Thus the document update associated with “19:00” is assigned a version indicating it is the more recent document update, such as “011”. Assigning a version to the document update tracks a version of the first document. For example, the first document update 106 is a different version of the first document 126 than a second document update. As a further example, the server 102 receives the first and the second document updates, assigns a version to each of these updates, based on their associated time stamps, in order to track the versions. In a further example embodiment, the assigned version 128 is also sent to the second computing device 124 with the first change 122.

Module 116, compares the first document update 106 to a first document 126 to identify the first change 122. After the first change 122 is identified, it is sent to the second computing device 124. The first change 122 may include many of the changes that were identified between the first document update 106 and the first document 126. The first change 122 may include the edits, changes, or updates that were created on the first document 126 on the first computing device 104. For example, once a user edits a word processing file document on the first computing device 104, it becomes the first document update 106 which is sent to the server 102. The processor 108 compares the first document 126 to the first document update 106 to identify the first change 122 created on the word processing file document. The first change 122 may then be transmitted to the second computing device 124.

Communication module 120 may transmit the first change 122 to the second computing device 124. The communication module 120 may include a network interface, a network communication, or other communication network that is suitable to transmit the first change 122 to the second computing device 124. In one example embodiment, the communication module 120 also receives the first document 126 and the first document update associated with the first time stamp 106. In a further example embodiment, the communication module may receive a second document update associated with a second time stamp. In this example embodiment, the server 102 transmits the first change 122 and receives the second document update associated with the second time stamp from the second computing device 124.

The first change 122 identified at module 116 may be transmitted from the server 102 to the second computing device 124. In one example embodiment, the first change 122 includes only the deleted, added, changed, or updated portion of the document. For example, assume there a word processing file document with a changed name, the updated portion includes the changed name which is sent to the second computing device 124. By sending the first change 122, the server 102 uses fewer resources as it may be a much smaller size file size than transmitting the first document update 106. In a further example embodiment, the first change 122 is sent to additional computing devices. Sending the first change 122 to additional computing devices allows an updated document to be synchronized among several computing devices.

In a further example embodiment, the assigned version 128 is also sent to the second computing device 124 with the first change 122. Sending the version 128 associated with the first change at module 114 enables the second computing device 124 to determine which changes corresponding to the document updates have already been received. For example the assigned version 128 of “003” may indicate there have already been three document updates versions of “001”, “002”, and “003” received on the server 102. Yet the second computing device 124 may have received only the changes corresponding to the third document update as indicated with the assigned version 128 of “003”. The second computing device 124 may then communicate with the server 102 to further obtain the changes corresponding to the document updates for the first two document updates by communicating with the server 102 for changes corresponding to “001” and “002”.

The second computing device 124 receives the assigned version 128 and the first change 122 to incorporate. In one example embodiment, the first document 126 also resides on the second computing device 124 so the first change 122 is incorporated into the first document 126. The second computing device 124 may include, for example, a client device, personal computer, desktop computer, laptop, mobile device, portable device, or any other computing device suitable to receive changes, such as the first change 122.

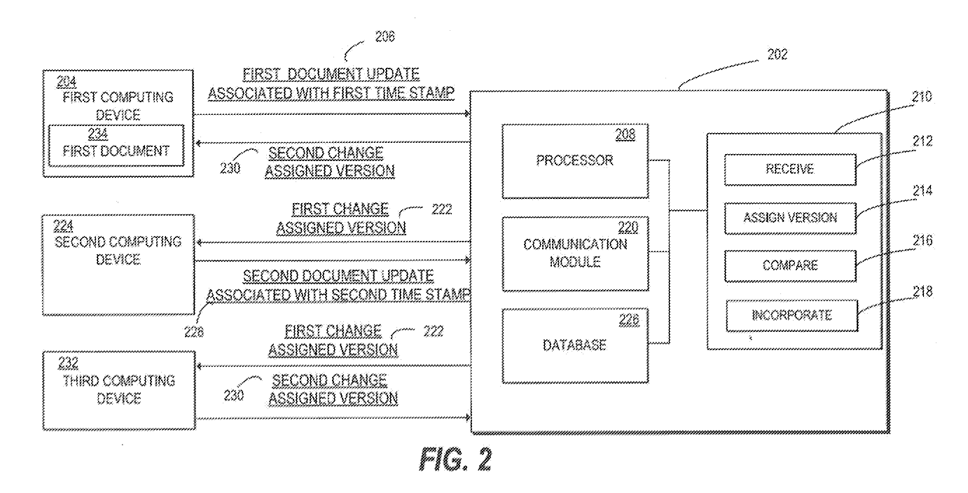

Moving to FIG. 2, a block diagram depicts communication between a first computing device 204, a server 202, a second computing device 224, and a third computing device 232. Specifically, FIG. 2 depicts communication with at least two document updates 206 and 228 and at least two changes 222 and 230 between a plurality of computing devices 204, 224, and 232. Although FIG. 2 depicts the first, second, and third computing devices 204, 224, and 232, respectively, it may include additional computing devices. For example, there may be a fourth and/or fifth computing device, etc. Thus, the changes 222 and 230 may be sent among a plurality of computing devices.

The first computing device 204 provides a first document 234 and a first document update associated with a first time stamp 206 to the server 202. The first computing device 204 includes the functionality of the first computing device 104 as set forth above in FIG. 1. Specifically, the first computing device 204 places the first document associated with the first time stamp in a memory cache on 204 until there is a connection to the server 202. Placing the first document update in the cache on 204 allows the first document update to be created when the first computing device 204 is off-line. In this example embodiment, the first document update and the first time stamp 206 are placed in the memory cache on the first computing device 204. When the first computing device 204 connects to the network, the first document update associated with the first time stamp 206 is transmitted from the memory cache to the server 202. The first computing device 204 includes a first document 234, also referred to as a master document. Thus, the terms first document 234 and master document may be used interchangeably herein. The first document update 206 includes the first document with at least a change.

Further, when the first document 234 is updated to provide the first document update 206, it is associated with a time stamp. For example, the first document update may include the changes to text on the word processing file document and these changes are associated with a first time stamp. Embodiments of the time stamp include a time and/or date of when the document update is created, and/or stored on the memory cache of the first computing device 204. For example, a word processing file document with a list of names, when a name is changed, there is a time stamp, such as “18:45” that represents the time of the change. Representing the time of change allows the server 202 to determine the more recent document update to then assign a version at module 214. A first time stamp of “18:45” representing the time of change to name on a word processing file is not as recent of an update as a second time stamp “19:00” representing other changes to the word processing file document. Thus, the time stamp “19:00” will be assigned a version indicating a more recent update. In this regard, the first and the second time stamps are considered associated with the first and the second document updates 206 and 228.

Yet, in a further example embodiment, the server 202 may receive other document updates. For example, the server 202 may receive a second document update 228 from the second computing device 224, and thus a second change 230 may be transmitted to the first computing device 204 and/or the third computing device 232 to incorporate into the document. Sending these changes, the document may be updated across the computing devices 204, 224, and 232.

The server 202 receives the first document update associated with the first time stamp 206 from the first computing device 204. Additionally, the server 202 also receives the first document 234 prior to receiving the first document update 206. In one example embodiment of FIG. 2, the server 202 includes processor 208, machine-readable storage medium 210, communication module 220, and database 226. Further, it is to be understood although the server 202 includes the depicted components, it should not be limited to containing the components in FIG. 2. For example, the server 202 may include an additional processor and/or communication module, etc.

Processor 208 may fetch, decode and execute modules 212, 214, 216, and 218 from the machine-readable storage medium 210. Modules 212, 214, 216, and 218 may include a single instruction or a set of instructions. In one example embodiment, the processor 208 executes: module 212 to receive the first document and the first document update associated with the first time stamp 206; module 214 to assign a version to the first document update based on the first time stamp 206; module 216 to compare the first document update to the first document to identify the first change 222; and module 218 to incorporate the first change 222 into the first document to produce a second document. In another example embodiment, the processor 208 executes: module 212 to receive a second document update associated with a second time stamp 228; module 214 to assign a version to the second document update based on the second time stamp 228; module 216 to compare the second document update to the second document to identify the second change 230; and module 218 to incorporate the second change 230 into the second document to produce a third document.

Machine-readable storage medium 210 includes executable instructions, firmware, and/or software modules which can be executed by the processor 208. These include module 212, 214, 216, and 218.

Module 212 receives the document update associated with the time stamp. In one example embodiment, 212 receives the first document update associated with the first time stamp. In another example embodiment, 212, receives the second update associated with the second time stamp 228. In a further embodiment, module 212 also receives the first document 234 prior to receiving the first document update associated with the first time stamp 206.

Module 214 assigns a version to the document update based on the time stamp. Example embodiments of 214 include incrementing a count, increasing or decreasing a value, or assigning a symbol to track a version of the first document. In one example embodiment, 214 assigns a version to the first document update based on the first time stamp 206, while in another example embodiment 214 assigns a version to the second document update based on the second time stamp 228. For example, the first document update 206 may have a time stamp of “18:45”, the second document update 228 may have a time stamp of “19:00”. The first document update 206 may be assigned to a version of “004” while the second document update 228 may be assigned “005”. The version “005” indicates a more recent document update than “004”. Assigning a version to each document update 206 and 228 tracks a version of the first document 234. In this regard, the first document update 206 is considered a different version of the first document 234 than the second document update 228. For example, the first document 234 may be a word processing file document on the first computing device 204 may be changed to provide the first document update 206. The first document 234 may be further edited on the second computing device 224 to provide the second document update 228. These document updates are assigned versions to determine which document update may be the most recent to transmit the corresponding changes. For example, the second document update 228 assigned version “0102” may be considered a more recent document update than the first document update 206 which was assigned version “0100”. In this sense, the first computing device 204 which already includes the first change 222 to provide the first document update 206, may further receive the second change 230 corresponding to the second document update. Additionally, the assigned versions to the first and second document updates are also transmitted to the computing devices 204, 224, and 232 with the first and second changes 222 and 230. Sending the assigned versions with the changes 222 and 230 enables the computing devices 204, 224, and 232 to determine which corresponding changes have been received. Referring back to the previous example, the assigned version “0100” may be sent to with the first change 222 to the second and third computing devices 224 and 232. The assigned version “0100” may be sent with the second change 230 to the first and third computing devices 204 and 232. The computing devices 204, 224, and 232 may further communicate with the server 202 to obtain any further or prior changes.

Module 216 compares the document update to a document to identify a change. In one example embodiment 216 compares the first document update 206 to the first document 234 to identify the first change 222. In another example embodiment, 216 compares the second document update 228 to a second document to identify the second change 230. The first document update includes at least a change to the first document 234. The second document includes the first changes 222 incorporated into the first document 234 while the second document update 228 includes the second document with a change or the first document 234 with a further change. For example, the first document 234 may reside on the second computing device 224 to provide the second document update 228. One example embodiment of the second document update 228 includes the first document 234 with further changes, edits, or updates created on the second computing device 224. In another example embodiment, the first document 234 may reside on the second computing device 224 with the first change 222 incorporated into the first document 234 so when this is further changed, edited, or updated, it provides the second document update 228. Module 218 incorporates the change identified at module 216 into the document to produce another document. In one example embodiment, 218 incorporates the first change 222 into the first document to produce the second document. In a further embodiment, 218 incorporates the second change 230 into the second document to produce a third document. Incorporating the changes into the document allows an updated document to be used in comparison for another document update, such as a third document update.

Communication module 220 sends the changes with the corresponding assigned versions 222 and 230 to the computing devices 204, 224, and 232. In one example embodiment, communication module 220 transmits the first change and assigned version 222 to the second computing device 224, while in another example embodiment the communication module 220 also transmits the first change and assigned version 222 to the third computing device 232. For example, the communication module 220 may transmit the first change and assigned version 222 to the second computing device 224 and/or third computing device 232 to incorporate the first change into the first document which resides on each device to update it. In a further example embodiment, the communication module 220 may also receive the first document update associated with the first time stamp 206 and/or the second document update associated with the second time stamp 228. In this embodiment the server 202 may transmit changes and assigned versions 222 and 230 and also receive document updates associated with time stamps 206 and 228.

The first change and assigned version 222 may be sent from the server 202 to the second computing device 224 and/or third computing device 232. The first change 222 includes the changes between first document update and the first document as identified at module 216. In keeping with the above example, the deleted and/or additional items added to a word processing file document would be the first change 222. There may be additional changes, such as the second change 230, however, there would need to be another document update, such as the second document update to correspond to the second change 230. Transmitting the changes 222 and 230 to computing devices 204, 224, and 232 to incorporate into a first document ensures the first document will be updated according to any document updates received on the server 202.

The second computing device 224 receives the first change 222 to incorporate into document. The second computing device includes the functionality of the second computing device 124 as set forth above in FIG. 1. Incorporating the changes 220 and/or 230 ensures document updates are synchronized on the computing devices 204, 224, and 232.

The database may store the first and second changes 222 and 230. In one example embodiment, the changes 222 and 230 are stored in a manner that corresponds with the assigned versions of the document updates. Using the previous example, the first and second document updates 206 and 208 may be assigned versions “0100” and “0102”, respectively. Thus the changes 222 and 230 may be stored in a manner that corresponds with “0100 and “0102”. Storing the changes 222 and 230 allows the computing devices 204, 224, and 232 to view, retrieve, and/or receive specific changes to synchronize. For example, the third computing device 232 may have received the second change and assigned version 230, but is missing the earlier changes, such as the first change, then the third computing device 232 may communicate with the server 202 to also receive the first change 222 in the database 226. Database 226, by way of example, may include a storage area, storage file, memory, or a number of physical media for storing data. For example, database 226 may include one or more hard disks, solid state drives, tape drives, flash drives, nanodrives, holographic storage devices, or any combination of such storage devices.

The second document update associated with the second time stamp 228 may also be received by the server 202. Although FIG. 2 depicts the second computing device 224 to provide the second document update associated with the second time stamp 228, this was done for illustrative purpose and should not be limited to this embodiment as the second document update associated with the second time stamp 228 may also be provided by the first computing device 204 or the third computing device 232. For example, the first and second computing devices 224 and 232 may include the first document 234 on each device, so when the first change 222 is received it may incorporated into the first document 234. If there are any further additions, deletions, changes, or updates, this provides the second document update 228. The second document update is also associated with the second time stamp to represent the time of the further additions, deletions, changes, or updates.

The second change and assigned version 230 is sent by the server 202 to the first computing device 204 and/or third computing device 232 to incorporate the change. However, a further example embodiment may include the second change 230 sent to the second computing device 224. In this sense, the second change 230 is sent to the devices that need to incorporate that particular change into the document to have the updated version of the document.

The third computing device 232 receives the first and/or second changes 222 and 230 to incorporate into the first document 234. In one example embodiment, the third computing device 232 receives first change and assigned version 222 while in a further example embodiment, the third computing device 232 also receives the second change and assigned version 230. For example, the third computing device 232 may transmit the second document update associated with the second time stamp to the server 202, thus the third computing device 232 would not need the second change 230 for the document to be updated. The third computing device 232 includes the functionality of the first and the second computing devices 204 and 232 and as such may include a client device, a personal computer, laptop, mobile device, portable device, or any other computing device suitable to transmit document updates with associated time stamps 206 and/or 228 and to receive changes 222 and/or 230. Although FIG. 2 depicts the third computing device 232 receiving first and second changes 222 and 230, it may receive either change 222 or 230 or both changes 222 and 230.

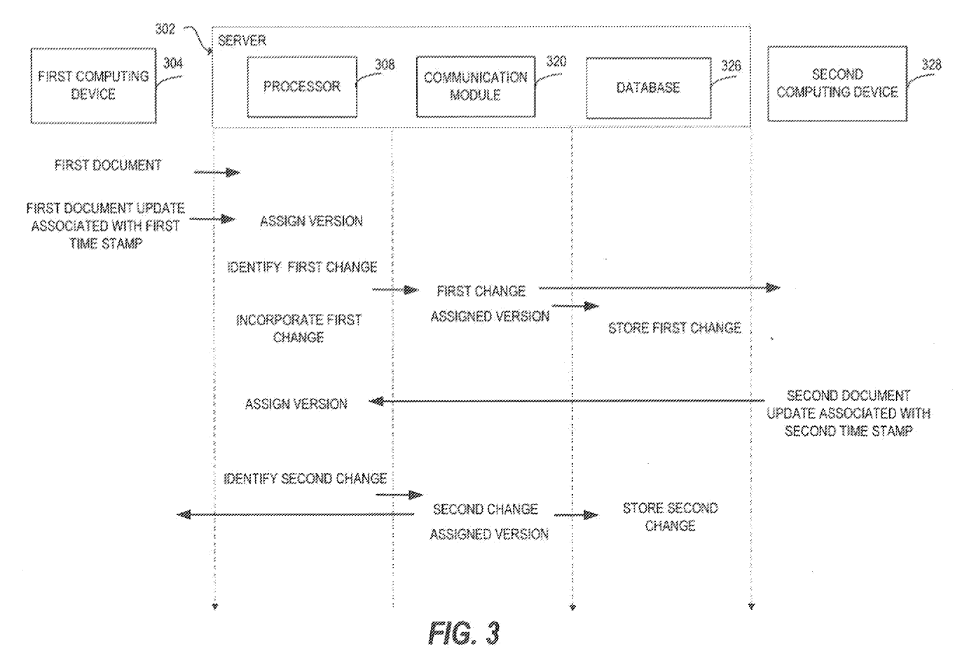

FIG. 3 depicts communication between a first computing device 304, a server 302, and a second computing device 328. Specifically, FIG. 3 depicts multiple document updates between two computing devices 204 and 328 as opposed to FIG. 2 which depicts communication with a plurality of computing devices. In this embodiment, the server 302 includes a processor 308, communication module 320, and a database 236. The server 302 includes the functionality as the server 102 and 201 in FIG. 1 and FIG. 2.

The first computing device 304 provides a first document and a first document update associated with a first time stamp to the server, specifically, processor 308. The first computing device 304 includes the functionality as the first computing device 104 and 204 in FIG. 1 and FIG. 2. In one example embodiment, the first document update associated with the first time stamp is placed into a memory, such as cache to be transmitted to the server 302. At the first computing device 304, a first document update is created and associated with a first stamp which is placed into memory cache and transmitted to the server 302. Further, although the first document is depicted as being received from the first computing device 304, this was for illustrative purposes and should not be limited to this embodiment. For example, the server 302 may receive the first document from the second computing device 328 or retrieve from a storage area on the server 302.

The processor 308 receives the first document prior to the first document update associated with the first time stamp. The processor 308 assigns a version to the first document update. Additionally, the processor 308 compares the first document update to a first document to identify a first change. Comparing the first document update to the first document allows the first change to be identified so the communication module 320 may transmit to the second computing device 328. Further, by assigning a version to the first document update, this assigned version may also be sent to the second computing device 328. This enables the second computing device 328 to determine which changes corresponding to the document updates have been received so the second computing device 328 can communicate with the server to obtain other changes.

In one example embodiment, the processor 308 incorporates the first change into the first document to provide a second document. The second document is used for further comparison to the second document update to identify the second change.

The processor 308 may also receive the second document update associated with the second time stamp. In one example embodiment, the second document update is received from the second computing device 328. The processor 308 assigns a version to the second document update. Further, the second document update is compared to the second document to determine the second change. The second change may be transmitted by the communication module 320 to the first computing device 304. Further still, the second change may be incorporated into the second document to create a third document.

The communication module 320 transmits the first change to the second computing device 328. In one example embodiment, the communication module 320 transmits the second change to the first computing device 304. Additionally, the communication module 320 may also transmit the assigned versions of the first and the second document updates. Sending the assigned version to the first and second document updates allows the first and the second computing devices 304 and 328 to communicate with the server 302 to obtain other changes.

Database 326 stores the first change and the second change. In one embodiment, the first and the second changes may be stored in a manner that corresponds with the assigned versions of the first and the second document updates.

The second computing device 328 may receive the first change to further incorporate into a document. The second computing device 328 includes the second computing device 124 and 224 in FIG. 1 and FIG. 2. In one example embodiment, the second computing device 328 may also create and transmit the second document update associated with the second time stamp.

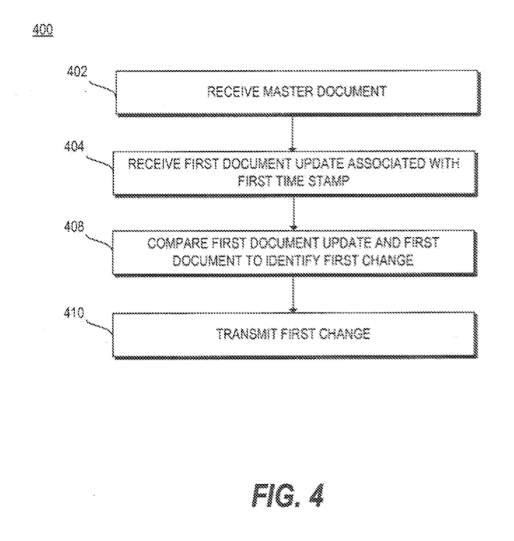

Referring now to FIG. 4, a flowchart of an example method 400 performed on a server for receiving a master document 402 and a first document update associated with a first time stamp 404 and transmitting a first change 410. In one example embodiment, the method 400 is performed on server 102 as seen in FIG. 1. Although execution of method 400 is described as being performed on server 102 as seen in FIG. 1, it may also be executed on other suitable components will be apparent to those skilled in the art. For example, method 400 may be implemented in the form of executable instructions stored on a machine-readable storage medium, such as storage medium 110, or in the form of electronic circuitry.

Operation 402 is performed such that the server receives the master document. The master document, also referred to as a first document, includes a at least one of a word processing file document, a spreadsheet file document, a media file document, Portable Document Format (PDF) file document, a text file document, or an archived file document. Thus, the terms master document and first document may be used interchangeably. The first document update includes the master document with at least a change. In one example embodiment, the master document may be received from a first computing device, while in another example embodiment the master document may be received from a second computing device, yet a further example embodiment the master document is retrieved by the server.

Operation 404 is executed such that the server receives the first document update associated with the first time stamp from the first computing device. The first document update includes the master document with at least a change. In example embodiments, the first time stamp represents the time of the change or the time the fist document update is placed into the memory, such as a cache on the first computing device before it is transmitted to the server. In another example embodiment of operation 404, a processor assigns a version to the first document update based on the first time stamp or an adjusted first time stamp. This may include incrementing a count, increasing or decreasing a value, or assigning a symbol to track a version number of the first document. For example, assume a count starts at “0000”, so the first document update may increase to “0100”. Assigning a version to the first document update allows document updates to be tracked to determine which document update may be the most recent to transmit the corresponding changes. For example, assume a computing device has already received a second change, but may be missing a first change, thus the computing device may communicate with the server to receive the first change. A further example includes if more than one document update is received by the server, by assigning a version to each document update determines the more recent update to send the corresponding changes to a computing device.

At operation 408, the processor compares the first document update to the master document to identify the first change. Comparing the master document to the first document update, allows the changes to be identified. By identifying the changes, these will be transmitted to a second computing device for further incorporation into a document to achieve an updated document. Operation 408, by way of example, includes a processor comparing the first document update and the master document to determine the first change. For example, assume the master document is word processing file document, then the first document update is the word processing document with changes. Both of these documents are compared to determine the changes which are transmitted to the computing device. By transmitting the changes to the second computing device to incorporate into the document, achieves an updated document.

At operation 410, a communication module transmits the first change to the second computing device. The second computing device may then incorporate the first change into the master document residing on the second computing device. For example referring back to the word processing file document example, the first change is transmitted to the second computing device to incorporate the changed text. In this regard, the master document on the second computing device may be synchronized to the first document update on the first computing device. Operation 410, by way of example, includes storing the first change to correspond with the assigned version of the first document. Operation 410, by way of further example, includes transmitting this assigned version with the first change. Sending the version corresponding to the first change enables the first or the second computing device to determine which changes corresponding to the document updates have already been received.

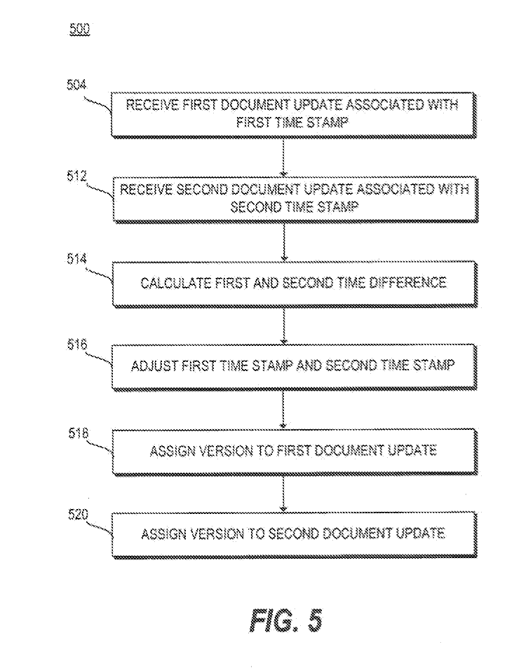

Referring now to FIG. 5, a flowchart of example method 500 performed on a server to receive first and second document updates associated with first and second time stamps at operations 504 and 512, respectively. Specifically, the method 500 adjusts the first and second time stamps when the first and second document updates are received simultaneous or in succession prior to a change being transmitted. For example, the first document update associated with the first time stamp may be received at operation 404 as seen in FIG. 4 or at operation 504 in FIG. 5, however during or after operation 404 or 504 but prior to operations 408-410, a second document update associated with the second time stamp is received at operation 512. The server, having received two document updates at operations 504 and 506 calculates two time differences at operation 514, adjusts the time stamps at operation 516, and at operations 518 and 520 assigns versions to the document updates based on the adjusted time stamps. Using the adjusted time stamps to assign versions to the document updates at operations 518 and 520 reflect utilizing accurate times to prioritize these document updates. Prioritizing the document updates enables a determination of the more recent document to transmit the corresponding changes. For example, after assigning the versions at operations 518 and 520, each of the document updates follow operations 408, and 410 to transmit the corresponding changes. Additionally, adjusting the time stamps at 516 accounts for when a time keeping function that generates a time stamp, such as a clock on a device, may be inaccurate. Adjusting the first and the second time stamps when the server receives the two document updates prior to transmission of a change corresponding to either of the two document updates, allows the more recent document update to be determined by the adjusted time stamps.

In one example embodiment, the method 500 is performed on server 102 as seen in FIG. 1. Although execution of method 500 is described as being performed on server 102 as seen in FIG. 1, it may also be executed on other suitable components will be apparent to those skilled in the art. For example, method 500 may be implemented in the form of executable instructions stored on a machine-readable storage medium, such as storage medium 110, or in the form of electronic circuitry.

At operation 504, the server receives the first document update associated with the first time stamp from a first computing device. In one example embodiment, operation 504 and 512 are performed simultaneously.

At operation 512, the server receives the second document updated associated with the second time stamp from a second computing device. In one example embodiment, operation 512 may be done in conjunction with operation 504. For example, the first and second document updates associated with the first and second time stamps may be received at the same time. In another example embodiment, operation 512 may be performed after operation 504, but prior to operations 408-410 as in FIG. 4.

At operation 514, the server calculates the first and the second time difference. In one embodiment, the first and second time difference includes a difference between a master time and a first and a second transmission time of the respective document updates. In this embodiment, the master time includes the server time. Example embodiments of the server time include world time, International Atomic Time (TAI), Terrestrial Time, Coordinated Universal Time (UTC), Global Positioning (GPS) time, or other sort of time generating function. The transmission time may include an additional time stamp that represents the time a document update is transmitted to the server. For example, assume the first time stamp is “21:00” and the second time stamp is “21:05”, the server time may be “21:15”, the first and the second transmission times may be “21:01” and “21:08”, respectively. Thus the first correction would be the difference between the first transmission time of the first document update and the server time which would be “00:14”, the first time stamp would be adjusted to “21:14”. The second correction would be the difference between the second transmission time of the second document update and the server time which is “00:07”, thus the second time stamp would be adjusted to “21:22”. In this example, the second time stamp is the more recent time stamp than the first time stamp, thus the second document update is considered the more recent update, since it is later in time.

At operation 516, the server adjusts the first and the second time stamps based on the first and second time difference at operation 514. The first and second time stamps are adjusted to accurately reflect the more recent document update. The more recent document update is used to determine in which order to send the changes out to a computing device. For example, in using the prior example, the second time stamp at “21:22” indicates the more recent document update since it was more recent in time than the first time stamp of “21:14”. In this example, the corresponding changes to first document update are transmitted prior to the changes corresponding to the second document update. Sending the more recent changes after, ensures the document is accurately updated. In a further example embodiment, the adjusted first and second time stamps may be identical. In this situation, both changes corresponding to the document updates may be transmitted to the computing device.

At operations 518 and 520, the first document and the second document updates are assigned a version based on the adjusted first time stamp. So in keeping with the following example, the first document update may be assigned “010” based on adjusted first time stamp “21:14” and the second document update assigned “011” based on the adjusted second time stamp of “21:22”. In this example, the second document update assigned “011” reflects the more recent document update. In a further example embodiment of operations 518 and 520, both the first and second document updates follow operations 408 and 410 to transmit the corresponding changes. In this embodiment, both the first and second document updates are compared to the master document to identify the first change and the second change. Then the first change and the second change may be transmitted. The transmission of the least recent change is transmitted prior to the more recent change. Sending the more recent changes afterward, ensures the document is accurately updated. In following with the previous example, the first change corresponding to the first document update is transmitted prior to the second change corresponding to the second document update.

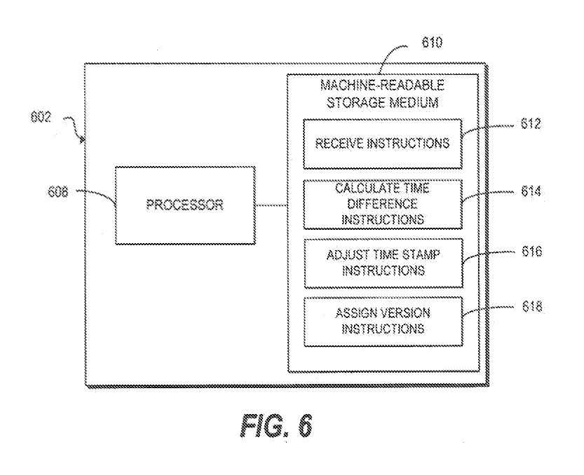

Turning now to FIG. 6, a block diagram of an example server 602 for receiving a first and a second document update to adjust the associated time stamps to assign versions to each of the document updates.

Processor 608 may fetch, decode, and execute instructions 612, 614, 616, and 618. Specifically, the processor 608 at instruction 612: receives a master document; a first document update associated with a first time stamp; and a second document update associated with a second time stamp. The processor 608 at instruction 614 calculates a first and second time difference between a master time and a first and second transmission time of the first and second document updates. Then the processor 608 adjusts the first and the second time stamps according to the first and second time difference at instruction 616 and the first and second document updates are assigned versions according to the adjusted first and second time stamps at instruction 618.

Machine-readable storage medium 610 may include instructions 612, 614, 616, and 618 for the processor 608 to fetch, decode, and execute.

The embodiments described in detail herein provide documents updates to a computing device.

1. A method comprising:
receiving, by a server, a master document;
receiving, by the server, a first document update from a first computing device, the first document update associated with a first time stamp and including a first change to the master document;
comparing the first document update to the master document to identify the first change; and
transmitting the identified first change, from the server, to a second computing device for incorporation into the master document on the second computing device.

2. The method of claim 1, further comprising assigning a version to the first document update based on the first time stamp to transmit to the second computing device.

3. The method of claim 2, further comprising storing the identified first change that corresponds with the assigned version of the first document update without storing the assigned version of the first document update.

4. The method of claim 2, further comprising:
receiving a second document update associated with a second time stamp, wherein the second document update includes a second change to the master document;
calculating a first and a second time difference between a master time and a first and a second transmission time of the first and the second document update, the master time including the server time; and
adjusting the first and the second time stamps based on the first and the second time differences.

5. The method of claim 4, wherein: assigning the version to the first document update based on the first time stamp utilizes the adjusted first time stamp.

6. The method of claim 5 further comprising assigning another version to the second document update based on the adjusted second time stamp.

7. The method of claim 1 wherein the identified first change is transmitted to the second computing device without transmitting the first document update.

8. A system comprising:
a processor to:
receive a first document;
receive a first document update associated with a first time stamp from a first computing device wherein the first document update includes a first change to the first document;
assign a version to the first document update based on the first time stamp; and
compare the first document update to the first document to identify the first change; and
a communication module to send the identified first change and the assigned version for incorporation into the first document on a second computing device.

9. The system of claim 8, wherein the processor is further to:
incorporate the first change into the first document o create a second document;
receive a second document update associated with a second time stamp, the second document update including a second change to the second document;
assign a version to the second document update based on the second time stamp;
compare the second document update to the second document to identify the second change; and
and the communication module is additionally to transmit the second change to the first computing device.

10. The system of claim 9 further comprising a database to store the first and the second changes without the document updates.

11. The system of claim 8 wherein the change is transmitted to the second computing device without the first document.

12. The system of claim 8, wherein the communication module broadcasts the first change to a plurality of computing devices.

13. A non-transitory machine-readable storage medium encoded with instructions executable by a processor, the storage medium comprising instructions to:
receive, by a server, a master document;
receive, by the server, a first document update from a first computing device, the first document update associated with a first time stamp and including a first change to the master document;
assign a version of the first document update based on the first time stamp;
comparing the first document update to a master document to identify a first change; and
send the identified first change and the assigned version to a second computing device for incorporation into the master document on the second computing device.

14. The non-transitory machine readable storage medium of claim 13, further comprising instructions to:
receive a second document update associated with a second time stamp, the second document update including a second change to the master document;
calculate a first and a second time difference between a master time and a first and a second transmission time of the first and the second document update, the master time tracked by the server; and
adjust the first and the second time stamps based on the first and the second time differences.

15. The non-transitory machine readable storage medium of claim 14, wherein the instruction to assign the version to the first document update based on the first time stamp further comprising the instruction to utilize the adjusted first time stamp.
